(19) United States
(12) Patent Application Publication
(10) Pub. No.: US 2020/0034481 A1
(43) Pub. Date: Jan. 30, 2020

(54) LANGUAGE AGNOSTIC DATA INSIGHT HANDLING FOR USER APPLICATION DATA

(71) Applicant: Microsoft Technology Licensing, LLC, Redmond, WA (US)

(72) Inventors: Matthew W. ASPLUND, Kirkland, WA (US); Chuck J. STREMPLER, Seattle, WA (US); Urmi GUPTA, Sammamish, WA (US)

(21) Appl. No.: 16/179,806

(22) Filed: Nov. 2, 2018

Related U.S. Application Data
(60) Provisional application No. 62/703,407, filed on Jul. 25, 2018.

(51) Int. Cl. G06F 17/30; G06F 17/28; G06F 17/27

(52) U.S. Cl. CPC G06F 17/30705; G06F 17/30696; G06F 17/275; G06F 17/30525; G06F 17/28; G06F 17/30722

(57) ABSTRACT

An electronic processor implemented method of providing results for a dataset. The method includes receiving the dataset and a user query relating to the dataset. The method further includes determining a language associated with a language-dependent data element in the dataset, and converting, based on the determined language, the language-dependent data element into a numerical representation of the language-dependent data element and assigning a classification to the numerical representation of the language-dependent data element. The method further includes generating an insight result based on the user query and the dataset including the numerical representation of the language-dependent data element and the assigned classification. The insight result includes at least one result from a data analysis of the dataset based on the user query. The method further includes outputting the insight result to a user interface.

### CROSS REFERENCE TO RELATED APPLICATION

This application claims priority from U.S. Provisional Patent Application No. 62/703,407 filed Jul. 25, 2018, the contents of which are incorporated herein by reference.

### SUMMARY

Various user productivity applications allow for data entry and analysis. These applications can provide for data creation, editing, and analysis using spreadsheets, presentations, documents, messaging, or other user activities. Users can store data files associated with usage of these productivity applications on various distributed or cloud storage systems so that the data files can be accessible wherever a suitable network connection is available. In this way, a flexible and portable user productivity application suite can be provided.

However, the information technology industry has continually increased the amount of information as well as the quantity of sources of information. Users can be quickly overwhelmed with data analysis due to the sheer quantity of data or number of options available for managing and presenting the data and associated analysis conclusions. Moreover, users within an organization have a difficult time leveraging the data and analysis of co-workers, and leveraging data analysis while switching between small form-factor devices (such as smartphones and tablet computers) and large form-factor devices (such as desktop computers).

Additionally, the data may be provided in different languages, which can, in some instances, require additional analysis by a user to understand the data and how to process it. Alternatively, even if the user has access to analysis modules for automatically analyzing the data, the user may be required to load one or more language modules to analyze the data, which can require additional storage on the user's system, as well as additional processor resources, leading to longer load times and analysis. Similarly, a relevant language module may not be available for analyzing particular data in particular ways as resources may limit the development of (for example, training) an analysis module in multiple languages.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter. Additional aspects, features, and/or advantages of examples will be set forth in part in the description which follows and, in part, will be apparent from the description or may be learned by practice of the disclosure.

Non-limiting examples of the present disclosure describe systems, methods and devices for providing dataset insights for a productivity application.

For example, one embodiment provides an electronic processor implemented method of providing results for a dataset. The method includes receiving the dataset and a user query relating to the dataset. The method further includes determining a language associated with a language-dependent data element in the dataset, and converting, based on the determined language, the language-dependent data element into a numerical representation of the language-dependent data element and assigning a classification to the numerical representation of the language-dependent data element. The method further includes generating an insight result based on the user query and the dataset including the numerical representation of the language-dependent data element and the assigned classification. The insight result includes at least one result from a data analysis of the dataset based on the user query. The method further includes outputting the insight result to a user interface.

Another embodiment provides a system for providing dataset insights for a dataset. The system includes a memory for storing executable program code, and one or more electronic processors, functionally coupled to the memory. The electronic processors are configured to receive the dataset and a user query relating to the dataset, and determine a language associated with a language-dependent data element in the dataset. The electronic processors are further configured to convert, based on the language, the language-dependent data element into a numerical representation of the language-dependent data elements, and assign a classification to the numerical representation of the language-dependent data element. The electronic processors are further configured to provide the user query, the dataset including the numerical representation of the language-dependent data element and the assigned classification to a recommendation element for generating an insight result for the dataset. The insight result includes at least one result from a data analysis of the dataset based on the query. The electronic processors are further configured to output the insight result to a user interface.

Another embodiment provides for a non-transitory computer-readable storage device including instructions that, when executed by one or more electronic processors, perform a set of function to provide dataset insights for a data set. The functions include receiving a user query to generate an insight associated with the dataset, and determining a language associated with a language-dependent data element in the dataset. The functions further include converting, based on the data, the language-dependent data element into a numerical representation of the language-dependent data element and assigning a classification to the numerical representation of the language-dependent data element, and generating an insight result for the dataset by providing the user query and the dataset including the numerical representation of the language-dependent data element and the assigned classification to a recommendation element configured to perform a data analysis of the data based on the user query. The functions further include outputting the insight result to a user interface.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a data insight environment in an example.

FIG. 2 illustrates operations of data insight environments in an example.

FIG. 3 illustrates operations of data insight environments in an example.

FIG. 4 is a first exemplary method for providing insight results in a productivity application.

FIG. 5 is a second exemplary method for providing dataset insights for a productivity application.

FIG. 6 illustrates a computing system suitable for implementing any of the architectures, processes, and operational scenarios disclosed herein.

FIG. 7 illustrates a data insight environment relating to an application for generating dataset insights for a productivity application using language agnostic recommendation elements.

FIG. 8 is an exemplary method for determining dimensional and classification of data within the application of FIG. 7.

### DETAILED DESCRIPTION

User productivity applications provide for user data creation, editing, and analysis using spreadsheets, slides, documents, messaging, or other application activities. However, due in part to continually increasing amounts of user data as well as the quantity of different sources of information, users can be quickly overwhelmed with tasks related to analyzing this data. In workplace environments, such as a company or other organization, users might have a difficult time leveraging the data and analysis performed by other co-workers. This level of growth in data analysis increases a need to augment a user's ability to make sense and use increasing sources and volumes of data.

In the examples herein, user data can be leveraged in various data visualization environments to create “insight” results or recommendations for users during data analysis stages. In some examples, insight results, as described herein, may comprise extensions of analytic objects that include charts, pivot tables, tables, graphs, and the like. In additional examples, insight results may comprise further content that represents an insight, such as summary verbiage, paragraphs, graphs, charts, pivot tables, data tables, or pictures that are generated for users to indicate key takeaways from the data.

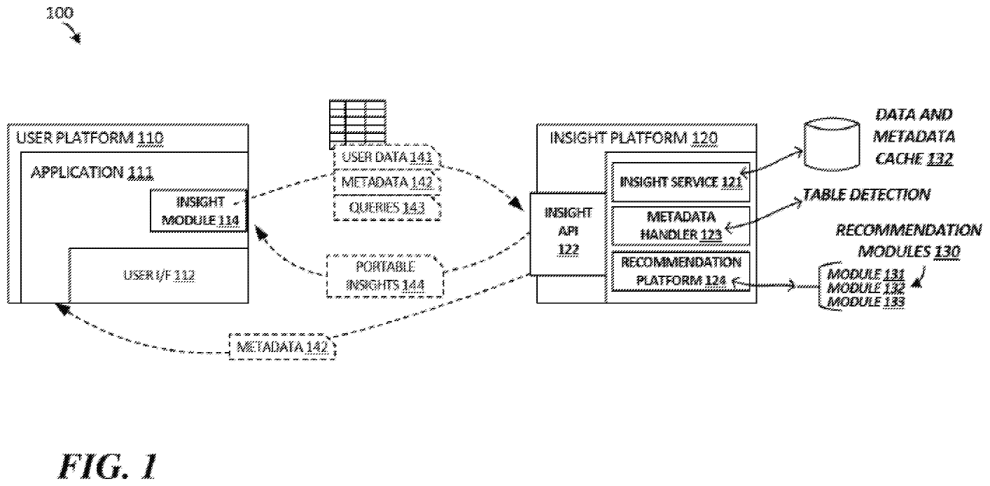

Turning now to a first example system for data visualization and insight generation, FIG. 1 is presented. FIG. 1 illustrates data visualization environment 100. Environment 100 includes user platforms 110 and an insight platform 120. Each of the elements of environment 100 can communicate over one or more communication links, which can comprise wired network links, wireless network links, or a combination thereof.

Each user platform 110 provides a user interface 112 to an application 111. The application 111 can comprise a user productivity application for use by an end user in data creation, analysis, and presentation. For example, the application 111 may include a spreadsheet application, a word processing application, a database application, or a presentation application. Each user platform 110 also includes an insight module 114. Insight module 114 can interface with the insight platform 120 as well as provide insight services within the application 111. The user interface 112 can include graphical user interfaces, console interfaces, web interfaces, text interfaces, among others.

The insight platform 120 provides insight services, such as an insight service 121, an insight application programming interface (API) 122, a metadata handler 123, and a recommendation platform 124. The insight service 121 can invoke various other elements of the insight platform 120, such as the insight API 122 for interfacing with clients. The insight service 121 can also invoke one or more recommendation modules, such as provided by recommendation platform 124.

In operation, the insight service 121 in coordination with the insight API 122, the metadata handler 123, and the recommendation platform 124 can process one or more datasets to establish data insight results, referred to in FIG. 1 as portable insights 144. The portable insights 144 can be provided to clients/user platforms configured to present graphical visualization portions, data descriptions or conclusions/summaries, object metadata, as well as the underlying datasets. The portable insights 144 can produce extensions of typical analytic objects, such as charts, graphs, tables, pivot tables, data descriptions, and other data or document presentation elements. Alternatively or in addition, the portable insights 144 can include other content that represents insight objects, such as verbiage or summary statements that provide additional information to a user, such as key takeaways of data insight analysis and other data descriptions.

In operation, a user of a user platform 110 or the application 111 may indicate a set of data or a target dataset for which data insight analysis is desired. This analysis can include traditional data analysis such as math functions, static graphing of data, pivoting within pivot tables, or other analysis. However, in the examples herein, an enhanced form of data analysis is performed, namely insight analysis. At the user application level, one or more insight modules are included to not only present insight analysis options to the user but also interface with the insight platform 120, which performs the insight analysis among other functions. Upon designation of one or more target datasets, a user can employ the insight service 121 via the insight API 122 to process the target datasets and generate one or more candidate insights, portable insight results, and associated insight metadata. In FIG. 1, this process is shown using user data 141 and optional metadata 142 supplied by the user and/or the application 111. However, it should be understood that target datasets can be supplied from other data sources, including in-application data sources, data documents, data storage elements, distributed data storage systems, other data sources, such as data repositories, or a combination thereof.

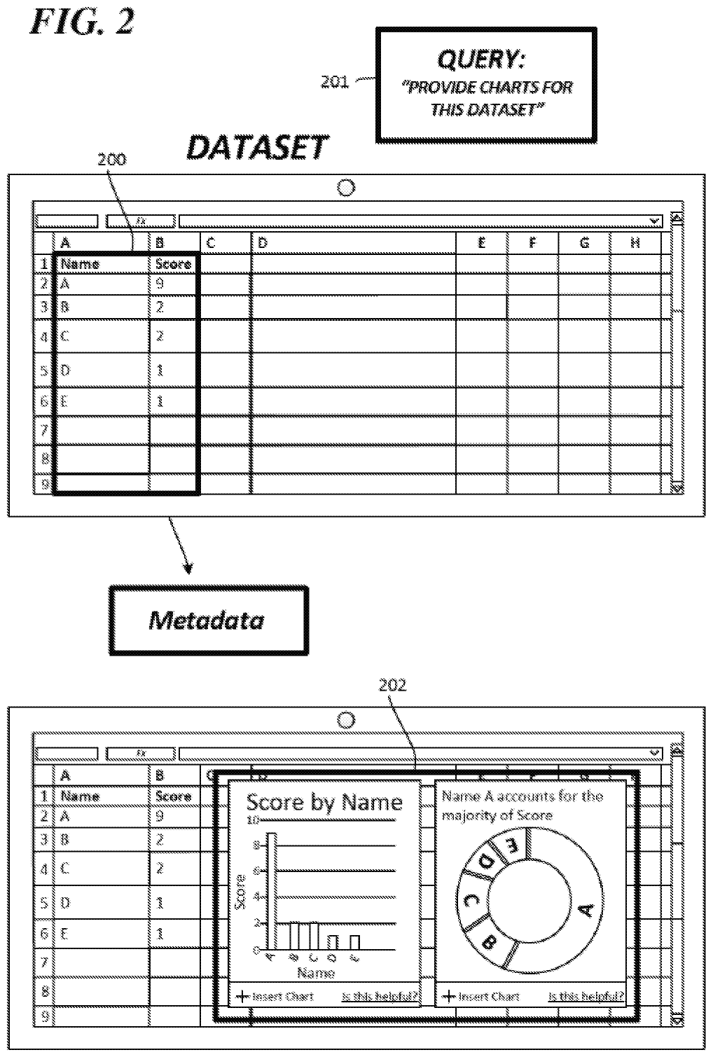

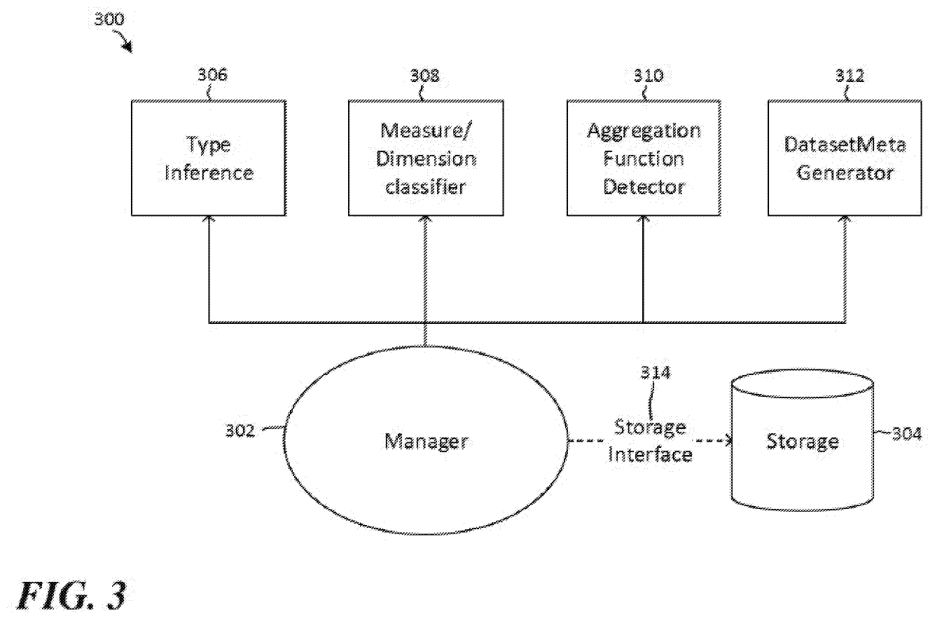

As mentioned above, metadata 142 can be provided with user data 141. The metadata 142 may be omitted (not provided with the user data 141) in some examples, and the metadata handler 123 of the insight platform 120 may be configured to determine such metadata. Metadata 142 can include properties or descriptions about user data 141, such as column/row headers, data contexts, application properties, and other information. Moreover, identifiers can be associated with the user data or with already-transferred user data and metadata. These identifiers can be used by the insight module 114 to reference the data/metadata within the insight platform 120. A further discussion of these identifiers is discussed below. Metadata processing performed by the metadata handler 123 is discussed in FIGS. 2-3 below.

The metadata handler 123 processes user data sets, such as user data 141, along with any user-provided or application-provided metadata 142 associated with the user data 141. The metadata handler 123 determines various metadata associated with user data 141, such as extracting properties, data descriptions, headers, footers, column/row descriptors, or other information. For example, when provided user data 141 includes a table with column and/or row headers, the metadata handler 123 can extract the column or row headers as metadata. Moreover, the metadata handler 123 can intelligently determine what the column/row information metadata might comprise in examples where metadata accompanies the provided user data 141 or when metadata does not accompany the user data 141. For example, the metadata handler 123 may determine properties of the user data 141 to establish metadata for the user data 141, such as data features, numerical formats, symbols embedded with the data, patterns among the data, column or row organizations determined for the data, or other data properties. Metadata 142 that might accompany user data 141 can also inform further metadata analysis by the metadata handler 123, such as when only a subset of the user data 141 is labeled or has headers.

After metadata is determined for the data sets, the metadata handler 123 can cache or otherwise store the metadata 142, along with any associated user data 141, in cache 132. The cache 132 can comprise one or more data structures for holding metadata 142 and user data 141 for use by the insight service 121 and the recommendation platform 124. The cache 132 can advantageously hold the user data 141 and metadata 142 for use over one or more insight analysis processes and user application requests for analysis. Various identifiers can be associated with the user data 141 or the metadata 142 for reference by the insight module 114 when performing further/later data insight analysis. Insight results determined for various user data sets can also be stored in association with the identifiers for later retrieval, referencing, or handling by any module, service, or platform in FIG. 1. Moreover, metadata and user data cached in the cache 132 can be employed in parallel by any of recommendation modules 130. In some examples, one or more components of the insight platform 120 (for example, the insight service 121, the metadata handler 123, the recommendation platform 124, or the insight API 122) may send metadata 142 back to user platform 110 upon metadata handler 123 determining properties associated with metadata 142. Metadata 142, and properties associated with the metadata 142, may be stored in association with the application 111 and/or a document containing a data set from which the metadata 142 was determined. Thus, in examples where metadata 142 is sent back to user platform 110, the insight module 114 may not have to communicate with cache 132 for further/later data insight analysis of a previously analyzed data set because the metadata 142 is stored with the application 111 in a user platform 110.

The insight service 121 establishes content of the data insight results according to processing a target user dataset using data analysis recommenders provided by the recommendation platform 124. The portable insights 144 can indicate insight results and insight candidates for presentation to a user by the application 111. For example, the portable insights 144 can describe insight results in a manner that can be interpreted by the application 111 to produce application-specific insight objects for presentation to a user. These insight objects can be presented in the user interface 112, such as for inclusion in a spreadsheet canvas of a spreadsheet application. Object metadata, such as metadata determined by the metadata handler 123, can accompany the portable insights 144.

To determine the data insight results, one or more recommendation modules 130 (sometimes referred to as recommenders) are employed. These recommendation modules 130 can be used to establish data analysis preferences derived from past user activity, application usage modalities, organizational traditions with regard to data analysis, individualized data processing techniques, or other activity signals. Knowledge graphing or graph analysis can be employed to identify key processes or data analysis techniques that can be employed in the associated insight analysis. Knowledge repositories can be established to store these data analysis preferences and organizational knowledge for later use by users employing the insight services discussed herein. Machine learning, heuristic analysis, or other intelligent data analysis services can comprise the recommendation modules 130. Each module 130 can be “plugged into” the recommendation platform 124 for use in data analysis to produce insight recommendations for the user data. For example, recommendation modules 131-133, among others, may be dynamically added or removed, instantiated or de-instantiated, among other actions, responsive to the user data 141, the metadata 142, desired analysis types, user instructions, application types, past analyses on user data, or other factors.

Turning now to a further discussion of the recommendation platform 124, the insight service 121 can grow to support one or more recommenders 130 and recommendation types. Recommenders 130 can use various integration steps to hook into the insight service 121. Below are example processes by which a new recommender 130 may register itself, as well as a processing pipeline for creating machine-learned intelligent recommenders 130.

Several terms are included in the discussion herein, which have example descriptions as follows. “Featurization” (sometimes also referred to as “Feature Extraction”) is a machine learning term used to describe a process of converting raw input into a collection of features used as inputs into a machine learning model. A “feature” comprises an individual measurement used as input to a machine learning model. “Metadata” can include information describing general properties about a given dataset, such as column types, data orientation, and the like. “Lazy Evaluation” comprises a process by which a value is only calculated when explicitly requested. A recommender 130 may comprise a single algorithm, either heuristic or machine-learning based, that takes in provided metadata from a dataset, and generates a set of recommendations, such as charts, tables, design, and the like. Through the application of featurization and machine learning, recommenders 130 can be intelligently trained to identify data structures and/or metadata associated with datasets that the recommenders 130 can generate insights for in association with the insight platform 120. Featurization and machine learning may be applied on an entity-specific basis, such that insight types (for example, charts, tables, design) that entities (for example, individual users, user demographics, corporate entities, entity groups) have indicated a preference for over time may be generated by appropriate recommenders 130. Thus, through the training of recommenders 130, and the application of lazy evaluation, only values that are associated with recommenders 130 that generate insight types that are relevant/preferred to specific entities need be calculated, thereby significantly reducing the processing costs associated with calculation of values related to non-preferred recommenders 130 and storage costs associated with caching or otherwise storing values for recommenders 130 that are not relevant to the entities.

During usage of the recommendation platform 124, sharing allows for easy sharing of as much code and resources as possible between training, testing, and production. Such sharing can be achieved using shared binaries and shared processing pipelines. Versioning allows for easily changing the versions of parts of a pipeline and ensuring parts of the pipeline are kept in sync. Quality controls may maintain a minimum quality bar for recommendation modules 130 with respect to accuracy, performance, or a combination thereof.

The development of a recommendation module 130 can be broken down into three stages: generation, validation, and production. The generation stage consists of either training a machine learning model or designing/implementing a heuristic-based algorithm. After a recommendation module 130 is created during the generation stage, the module 130 can be run through one or more rounds of validation. The validation may consist of a performance portion, a quality assurance portion, or a combination thereof. In some embodiments, each recommendation module 130 can be assigned a budget for processor time as well as minimum required accuracy, which can set the thresholds or goals for the validation stage. The production stage of the pipeline includes running each individual recommendation module 130 in production. The recommendation platform 124 can be responsible for federating out individual requests to all registered recommendation modules 130 and aggregating the results.

This design for recommender 130 development advantageously supports the ability for machine learning models to be trained on a feature set that is as identical as reasonable to what may be seen in real user data. This means that as updates are made to the supported recommendation module 130 feature set and associated generation logic, each recommendation module 130 can train a new model that can be utilized to match the new version, and the production service can ensure that the hosted models are in sync with their feature set version. A part of the recommendation platform 124 is the continued improvement and expansion of the features. To ensure that the machine learning/training models are working as expected, the same logic may be used to generate the features that are used to train the models as well as validate and run the modules 130.

Turning now to the operation of the insight API 122, various inputs and outputs are provided. As input, the insight API 122 can receive user data 141, such as datasets in a two-dimensional tabular format. In some examples, as described above, this user data 141 may have accompanying metadata 142. In other examples this user data 141 may have embedded metadata. In still other examples, this user data 141 may have no accompanying metadata. One or more applications and/or users associated with the infrastructure described herein may initiate one or more queries or questions posed toward user data 141. These queries are represented as queries 143 in FIG. 1 and can comprise natural language questions posed by users and/or applications related to the user data and submitted through the insight API 122 in a standardized format. A user might ask one or more questions for analysis by the insight platform 120, and provide a portion of data to insight platform 120. The queries indicated by the user and/or application, and included in queries 143, can include questions such as, “I need charts for this data . . . ” or “Provide the metadata for this data . . . ” or “Summarize this data . . . ” among other query types. The insight API 122 provides for input mechanisms for the application 111 through the insight module 114 to input the user data 141, the metadata 142, and the queries 143 for use by the insight service 121. Based on the inputs (for example, the user data 141, the metadata 142, the queries 143, or a combination hereof), the insight platform 120 provides, through the insight API 122, one or more insight results indicated by the portable insights 144.

As outputs, such as the portable insights 144, the insight API 122 can provide insight results in a standardized output for interpretation by any application to present the insight results to the user in that application's native format. Portable insights 144 comprise descriptions of the insight results that can be interpreted by the application 111 or the insight module 114 to generate visualizations of the insight results to users. In this manner, a flexible and/or portable insight result can be presented as an output by the insight API 122 and interpreted for display as-needed and according to specifics of the application user canvas.

The insight API 122 defines the formatting for inputs and outputs, so that applications and users can consistently present data, metadata, and queries for analysis by the insight platform 120. The insight API 122 also defines the mechanisms by which the application 111 can communicate with the insight platform 120, such as allowed input types, input ranges, and input formats, as well as possible outputs resultant from the inputs. The insight API 122 also can provide identifiers responsive to provided user data 141, metadata 142, and queries 143 so that data 141, metadata 142, and queries 143 can be referenced later by clients, such as the application 111, as stored in cache 132.

In one example, the insight API 122 comprises an insights representational state transfer (REST) style of API. The insights REST API comprises a web service for applying heuristic and machine learning-based analysis to a set of data to retrieve high level interesting views, called insights herein, of the data. The insights REST API can provide recommendations for charts and/or pivots of the user data. The insights REST API can also provide metadata services used for natural language insights and other analysis.

An example operation flow involving a client, such as the application 111, communicating with the insight API 122 may comprise the following flow.

At a first operation, a client uploads a range of client data to the service, which initiates a data session. In some examples, this may cause a URL to be returned containing a unique “range id” that is 1:1 with the data session. In examples where a user triggered refresh has occurred, a new “range id” may be generated and returned in a URL.

At a second operation, the client provides an indication of a type of analysis they want performed. Analysis options may include receiving recommendations for insights or metadata services used for natural language insights among other analysis choices. This returns an Operation ID, which is 1:1 with the process of performing the requested analysis.

At a third operation, the client waits for the operation to complete, periodically polling the service, and at a fourth operation the client is provided with an opportunity to cancel an operation.

At a fifth operation, the client gets the results of the completed operation. Additional requests may be made on the same data in cache 132 (for example, a user request to correct the metadata and get new recommendations), without needing to upload the data again. That is, the operation flow may return to the second operation.

At a sixth operation, the client closes the data session, and the data session ends.

To illustrate example data set handling and metadata determination, FIG. 2 is presented. FIG. 2 illustrates further operations of the elements of FIG. 1, although the operations of FIG. 2 can be implemented by elements other than those of FIG. 1. In operation, dataset 200 can be provided along with one or more queries 201 directed to the dataset to an insight platform. For example, dataset 200 and query 201 might be provided via the insight API 122 for processing by the insight platform 120 of FIG. 1. The insight platform 120 can process the dataset 200 and query 201 to provide an insight result, which can be interpreted by the application 111 for display as insight objects 202.

In FIG. 2, example dataset 200 is shown comprising a two-dimensional array of data in a spreadsheet application user interface. In some examples, the dataset 200 can comprise a table, pivot table, spreadsheet, or other dataset, or can be a subset thereof. As seen in FIG. 2, the dataset 200 comprises data along with metadata. The data included in the dataset 200 comprises user data values or user data entered for analysis. The metadata includes descriptions of the data, which in this case is column headers that indicate properties of the data contained in underlying columns. For example, the metadata in the example dataset 200 indicates a first column “name” and a second column “score.” When submitted through the insight API 122, the insight service 121 can employ the metadata handler 123 to isolate the metadata from the data, along with determining other metadata as appropriate. The data and the metadata can be stored in association with an identifier in the cache 132. As described above, the metadata handler 123 can provide table detection services for provided datasets. These table detection services can detect not only data arranged into two-dimensional arrays, such as tables, but also extract metadata that describes the data in the arrays.

The insight service 121 can initiate insight processing for the dataset using the metadata and one or more recommendation modules (for example, recommendation modules 131-133). These recommendation modules can process the datasets, the queries, and the metadata to determine one or more insight results using machine learning techniques, heuristic processing, natural language processing, artificial intelligence services, or other processing elements. The insight results, as discussed herein, are presented in a portable description format, such as using a markup language (for example, HTML, XML, or the like). A user application comprising insight handling functions can interpret the insight results in the portable format and generate one or more insight objects for rendering into a user interface and presentation to a user.

An exemplary portable insight client/application interaction, utilizing the insight service 121 and the insight API 122, is described below:
The insight module 114 sends data to the insight service 121. The insight service 121 replies with a location for RESTful resource tracking of the data.
The insight module 114 tells the insight service 121 to generate insight recommendation results and that the application is capable of rendering charts and PivotCharts. A long running task will be created on the insight service 121, and the insight service 121 replies with a RESTful resource that the insight module 114 can use to track this operation.
The insight module 114 queries state of operation and is told that the operation is running. The insight module 114 is also told to try polling again after a specified time lapse.
The insight module 114 queries state of operation later and is told that the operation has succeeded. The insight module 114 is also given the location of the created resource.
The insight module 114 asks for the insight recommendation results. In this example, there are two PivotChart recommendations, notably insight results that correspond to insight objects 202.
The insight module 114 tells the insight service 121 that the insight module 114 is done with the resource tracking the data. In some examples, the insight service 121 may store this data for a short amount of time (on the order of hours). In other examples, the notification that the insight module 114 is done with the resource tracking of the data provides the insight service 121 a request to clean up the resource immediately, thereby increasing storage capacity of one or more devices where the resource tracking data is stored.

As a further example involving the elements of FIG. 1, the application 111 can comprise a spreadsheet application, a word processing application, a presentation application, or other user application. The application 111 may comprise various user interface elements presented by user interface 112, such as windowed dialog boxes, a user canvas from which data can be entered and manipulated, various menus, icons, control elements, and/or status informational elements. Furthermore, the insight module 114 provides for enhanced user interface elements from which a user can initiate insight processing by the insight platform 120, such as responsive to a user selecting an insight trigger icon or entering an insight analysis command. In some examples, users may provide background services with authorization to monitor target data sets, which can be utilized to pre-compute insight results for presentation to a user.

Typically, a user may have a set of data entered into a worksheet or other workspace presented by the application 111. This data can comprise one or more structured tables of data and/or unstructured data and can be entered by a user or imported from other data sources into the workspace. A user may want to perform data analysis on this target data, and can select among various data analysis options presented by the user interface 112. However, typical options presented for data analysis by the user interface 112 and the associated application 111 may only include static graphs or may only include content that the user has manually entered. This manual content can include graph titles, graph axes, graph scaling, colors, and/or other graphical and textual content or formatting.

Example insight generation operations proceed according to a modular analysis provided by the recommendation modules 130. The insight service 121 can instantiate, apply, or otherwise employ one of the recommendation modules 130 to perform the insight analysis. As discussed herein, the insight analysis can include analysis processes that are derived by processing metadata, query structure and content, along with other data, such as past usage activities, activity signals and/or usage modalities that are found in the data. The target dataset can be processed according to various formulae, equations, functions, and the like to determine patterns, outliers, majorities/minorities, segmentations, and/or other properties of the target dataset that can be used to visualize the data and/or present conclusions related to the target dataset. Many different analysis processes can be performed in parallel.

Insight results are determined by the recommendation modules 130 and provided to the insight service 121 for various formatting and standardization into the portable format output by insight API 122. The insight API 122 can provide these portable insights for delivery to the insight module 114 of the application 111. Th insight module 114 can interpret the insight results in the portable format to customize, render, or otherwise present the insight results to a user in the application 111. For example, when the insight results procedurally describe charts, graphs, or other graphical representations of insight results, the application 111 (through the insight module 114) can present these graphical representations.

In FIG. 2, insight results can be rendered into insight objects 202, such as the two charts shown. Metadata extracted or determined for the dataset can be included in the insight results/objects to label axes, label data portions, or otherwise provide context and descriptions for the insight results/objects. The selection or choice of an object type, such as graph or chart type, can be determined based on the dataset content, the metadata, or according to the query presented, among other considerations. For example, the query might indicate that a graph or chart or particular graph/chart types are to be provided.

The insight objects 202 can be presented in a graphical list format, paged format, or other display formats that can include further insights objects 202 available via scrollable user interface operations or paged user interface operations. A user can select a desired insight object 202, such as a graph object, for insertion into a spreadsheet or other document. Once inserted, further options can be presented to the user, such as dialog elements from which further insights can be selected. Each insight object 202 can have automatically determined object types, graph types, data ranges, summary verbiage, supporting verbiage, titles, axes, scaling factors, or color selections, or other features. These features can be determined by the recommendation modules 130 using the insight results discussed herein, such as based on data analysis derived from the user data, the metadata, or the queries.

Further options can be presented to the user that allow for secondary manipulation of the insight objects 202 or insight results. Secondary manipulation can include manipulation of the dataset or metadata to perform further insight analysis. Secondary manipulation can include various queries or questions that a user can ask about the insight object 202 presently presented to the user, such as questions including “what happened,” “why did this happen,” “what is the forecast,” “what if . . . ” “what's next,” “what is the plan,” “tell this story,” and the like. For example, a question “what does this insight mean?” can initiate various follow-up analysis on the datasets or details used to generate the insight, such as descriptions of the formulae, rationales, and data sources used to generate the insight. The formulae can include mathematical or analytic functions used in processing the target datasets to generate final insight objects or intermediate steps thereof. The rationales can include a brief description of why the insight was relevant or chosen for the user, as well as why various formulae, graph types, data ranges, or other properties of the insight object were established. For example, data analysis preferences derived from metadata, initial queries, or past data analysis might indicate that bar chart types are preferred for the datasets.

Forecasting questions can be queried by the user, such as in the form of “what if” questions related to changing data points, portions of datasets, graph properties, time properties, or other changes. Also, iterative and feedback-generated forecasting can be established where users can select targets for data conclusions or datasets to meet and examining what data changes would be required to hit the selected targets, such as sales targets or manufacturing targets. These “what if” scenarios can be automatically generated based on the insight datasets, metadata, or queries. Moreover, the insight object 202 can act as a “model” with which a user can alter parameters, inputs, and properties to see how outputs are affected and predictions are changed.

Insight results/objects can comprise dynamic insight summaries, verbiage, or data conclusions. These insight summaries can be established as insight objects that explain a key takeaway or key result of another insight object. For example, an insight summary can indicate “sales of model 2.0 were up 26% in Q3 surpassing model 1.0.” This summary may be dynamic and tied to the dataset/metadata associated with the insight object, so that when data values or data points change for an insight object, the summary can responsively change accordingly. Data summaries can be provided with the insight results and include titles, graph axis labels, or other textual descriptions of insight objects. The summaries can also include predictive or prospective statements, such as data forecasts over predetermined timeframes, or other statements that are dynamic and change with the insight object.

For further examples on metadata handling, such as determination and extraction of metadata for various datasets, FIG. 3 is presented. FIG. 3 includes flow diagram 300 that illustrates an example operation of the elements of FIG. 1. In FIG. 3, a metadata manager 302 is presented as an example of the metadata handler 123. The metadata manager 302 can interface with one or more storage elements (for example, storage 304), over storage interfaces (for example, storage interface 314). The storage elements can be examples of the cache 132 in FIG. 1, although further configurations can be employed. The storage elements can store metadata and user datasets for use during processing by various insight determination elements or recommendation modules, or for usage in later insight requests from users.

Turning now to the operation of elements of FIG. 3, datasets, query information, and user-provided metadata can be delivered to an insight platform that includes a metadata manager 302. The metadata manager 302 can process the provided datasets/queries/metadata to determine further metadata associated with the datasets. This metadata can be employed in insight processing by one or more recommendation modules. As shown in FIG. 3, the metadata manager 302 can provide various services such as data type inference, data measure/dimension classification, and data aggregate function detection. Outputs from these services can be provided to a dataset metadata generation service for processing and output of metadata for the associated datasets.

A further discussion of the metadata operation continues below. In an example, operation of metadata components illustrated in FIG. 3 may comprise the following:
Metadata is computed once and reused across different recommenders of the insight service.
Internal subcomponents of the metadata system are typically not recomputing metadata properties that are computed by other subcomponents.
Metadata is cached and typically not recomputed across multiple requests for the metadata.
Whenever a property of the metadata changes (for example, through a user action), only the metadata properties that depend on the changed property are typically recomputed.
The metadata service can be divided into two major parts: a set of components that compute individual pieces of metadata, and a manager 302 class which holds references to each of the components.

As mentioned above, various components form the metadata services. The type inference component 306 determines the type of each column of a dataset. A measure v/s dimension classification component 308 classifies each column as a dimension or a measure. An aggregation function detector component 310 suggests aggregation functions for each column. A DatasetMeta generator component 312 generates the DatasetMeta object. A sequential detector component determines whether the data in a column is sequential in nature. It should be noted that the term ‘column’ can instead be referred to as a ‘field’ in further examples.

The metadata manager 302 can comprise a software component “class” that maintains a list of metadata components. Additionally, the manager 302 class may also maintain an interface to a cache to ensure that re-computation of the metadata for the same input is not necessary. The cache may store a task for every metadata operation being run. This is so that multiple components requesting the metadata can wait on the task if it is still running or directly get the results without waiting if the task has completed. In some examples, the recommenders/providers may only be able to access the metadata through the manager 302 class.

An example metadata manager 302 class can be defined as follows:

```
static class MetadataManager
{
    static MetadataManager( )
    {
    }
    public static IMetadata GetMetadata(ITableView data)
    {
    }
}
public interface IMetadata
{
    Task<IColumnTypes> ColumnTypes { get; }
    Task<IColumnMeasureDimensionHints> MeasureDimensionHints
    { get; }
    Task<IColumnAggregationFunctionTypes>
ColumnAggregationFunctionTypes { get; }
    Task<IColumnSequentialities> ColumnSequentialities { get; }
    Task<DatasetMeta> DatasetMeta { get; }
}
```

Input to each of the metadata processing components can be the raw datasets and any additional metadata that is obtained from the client (for example, cell formats). The metadata components may be aware of the metadata manager 302 so that they can obtain any additional metadata. For example, if the measure/dimension classifier requires column types, it can request types from the manager 302 class which may subsequently call the type detection component, if those types do not already exist in its cache. Each of the components may implement task-based parallelism. This allows multiple components to wait on the results of a component.

The type inference component 306 may comprise a platform into which multiple type inference providers can be “plugged.” The provider may accept a standard input and provide types in a standard output format. The input may be a structured form of the data and the output may be a collection of types. Each of the types may have one or more confidence metrics associated with them. The collections of the types from all providers may be provided as input to an aggregation algorithm that may be used to determine a final type for each column.

Turning to a further discussion of the elements of FIG. 3, the measure/dimension classifier component 308 takes as input the output of the type inference process. The classifier may have a design similar to the type inference system where there may be multiple providers that output their results into an aggregation algorithm to determine the final type decision for one or more columns. The Aggregation Function Detector component 310 generates a list of aggregation functions for measures. The DatasetMeta Generator component 312 creates the DatasetMeta object. The Sequential Data Detector determines whether the given data is sequential in nature.

Input and Output Interfaces can also be defined for the metadata components. The input to the metadata manager 302 and its components may comprise a form of an interface IRangeData that provides the Cell Values, Cell formats, and the Column Headers. The metadata manager 302 and its components may be agnostic of the column orientation. The metadata manager 302 may detect table orientation in the table recognition step that is independent of metadata detection.

An example table recognition process can be as follows:

```
interface ITableView
{
  IEnumerable<string> ColumnHeaders { get; }
  IEnumerable<IEnumerable<string>> ColumnData { get; }
  IEnumerable<string> ColumnFormats { get; }
  IEnumerable<IEnumerable<string>> CellFormats { get; }
}
interface IColumnTypes
{
  IEnumerable<FieldDataType> ColumnTypes { get; }
}
  interface IColumnMeasureDimesionHints
{
  IEnumerable<MeasureDimensionHint> MeasureDimensionHints
  { get; }
}
interface IColumnAggregationFunctionTypes
{
  IEnumerable<IEnumerable<AggrFunc>> AggregationFunctions { get; }
}
```

The internal structure of the type inference component 306 may also be implemented as a platform. Two or more type inference algorithms can be used. A first type inference algorithm may be based on number formatting that is obtained from a client application. A second type inference algorithm may be based on a preprocessor. Each algorithm may take as input a string array representing a single column and return an array of types for the column. Each type may have a confidence level associated with it. In some examples, the confidence levels may be fed into an aggregation algorithm that may generate a single type for each column. These types may be added to the DatasetMeta that is passed in. Further examples can add the entire list of types inferred along with the confidence metrics in the DatasetMeta. The internal structure of the dimension/measure classifier component 308 may have a similar pattern as the type inference component 306 with multiple classifiers whose results may be fed into an aggregation algorithm to generate a set of dimensions and a set of measures.

Further examples of metadata handling components that may be incorporated for generating insights and selecting appropriate insight types for datasets can include implementing a cache so that metadata does not need to be recomputed across multiple requests, and implementing a dependency graph so that on changes to metadata properties, only properties that depend on the changed properties need to be recomputed.

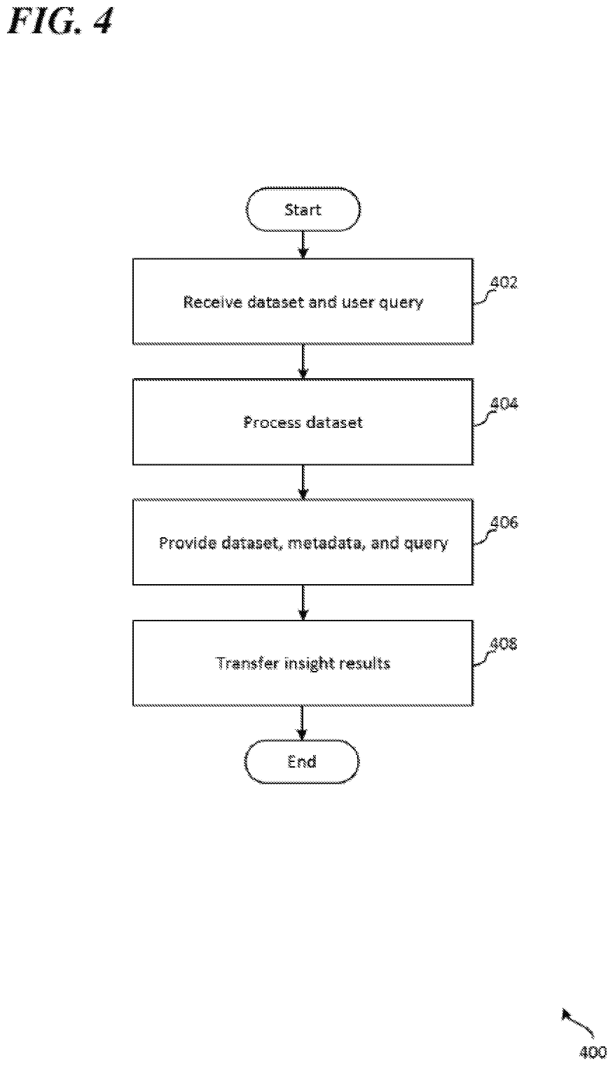

FIG. 4 is a first exemplary method 400 for providing insight results in a productivity application. The method 400 begins at a start operation and flow continues to operation 402 where a dataset and a user query relating to the dataset are received. In some examples the dataset may comprise a plurality of values comprised in one or more columns or rows of a productivity application. In additional examples the dataset may comprise a table or a pivot table of a productivity application. In still other examples, the dataset may comprise a plurality of values obtained from a data source accessed by one or more components of a user platform, such as the user platform 110 illustrated in FIG. 1 and/or one or more components of an insight platform, such as the insight platform 120 illustrated in FIG. 1.

In some examples, the user query received at operation 402 may comprise a natural language question posed by a user of a productivity application. In some examples, the user may provide the query to the productivity application via a verbal or typed input type. In other examples, the user query may be initiated by a user providing an input to a productivity application (for example, hovering a mouse, providing a mouse click, touching a touch-sensitive display, or the like) in the vicinity of a target dataset in the productivity application. Upon receiving the initiation of the user query via the user input to the productivity application, one or more selectable user interface elements may be provided for sending a corresponding user query corresponding to the selected target dataset to one or more components of the insight platform 120. In some examples, the selectable user interface elements may be provided for selection based on past user data related to the productivity application and/or past user data related to dataset queries provided to the productivity application.

From operation 402, flow continues to operation 404 where the dataset is processed to determine metadata that describes one or more properties of the dataset. The metadata may be provided by the user and/or a productivity application associated with the dataset. In examples, the metadata may comprise properties or descriptions associated with the received dataset, such as column and/or row headers, footers, data contexts, data orientations, and application properties of the productivity application. In some examples, the metadata may be determined by a metadata handler to establish metadata for the dataset. For example, a metadata handler may analyze one or more features associated with dataset, such as data features included in the dataset, value types included in the dataset, symbols in the dataset, values included in the dataset, and/or patterns included in the dataset, and assign metadata to the dataset based on the analysis. In some examples, the metadata associated with the dataset may be cached for later processing of the received dataset or datasets that are determined to be similar to the received dataset.

From operation 404, flow continues to operation 406 where the dataset, metadata, and query are provided to one or more modular recommendation elements (recommendation modules 130) for processing into an insight result for the dataset that indicates a result from data analysis directed to the query. The one or more modular recommendation elements may utilize one or more of past user activity, application usage modalities, organizational traditions with regard to data analysis, and/or individualized data processing techniques in processing the dataset, metadata, and query. For example, if past user activity associated with the productivity application indicates that the user prefers that one or more specific insight types (for example, a graph of a dataset, a textual explanation of information associated with a dataset, projections associated with a dataset, or the like) be provided based on a query type that is similar to the received query and/or a dataset type that is similar to the received dataset, the one or more modular recommendation elements may process the dataset, metadata, and query into an insight result corresponding to the user's preferences.

From operation 406, flow continues to operation 408 where insight results are transferred for use by the productivity application in displaying one or more insight objects based on the insight result. The one or more insight objects may comprise charts, tables, pivot tables, graphs, textual information, interactive visual application elements, selectable application elements for audibly communicating information associated with the dataset, and/or pictures. The one or more insight objects may provide visual and/or audible indications of information associated with the dataset, summaries of key takeaways associated with the dataset, comparisons of information from the dataset with one or more other datasets related to the dataset, and projections for one or more values or categories associated with dataset.

In some examples, the one or more values of a dataset corresponding to one or more of the displayed insight objects and/or metadata associated with a dataset corresponding to one or more of the displayed insight objects may be interacted with and a display element associated with the interaction may be reflected in one or more affected insight objects. In other examples, one or more of the displayed insight objects may be interacted with and a corresponding one or more values of the dataset, or a related dataset may be modified in associated with the interaction. In additional examples a user may provide, via the productivity application, follow-up queries related to the insight results (for example, “what happened”, “why did this happen”, “what is the forecast”, “what if . . . ”, “what's next”, “what is the plan”, “tell this story”), and additional analysis may be performed for providing information related to a received follow-up query (for example, providing a description of formulae utilized in generating the insight results, providing a description of rationales for the displayed insight objects, providing a description of data sources used to generated the displayed insight objects).

From operation 408 the method 400 continues to an end operation, and the method 400 ends.

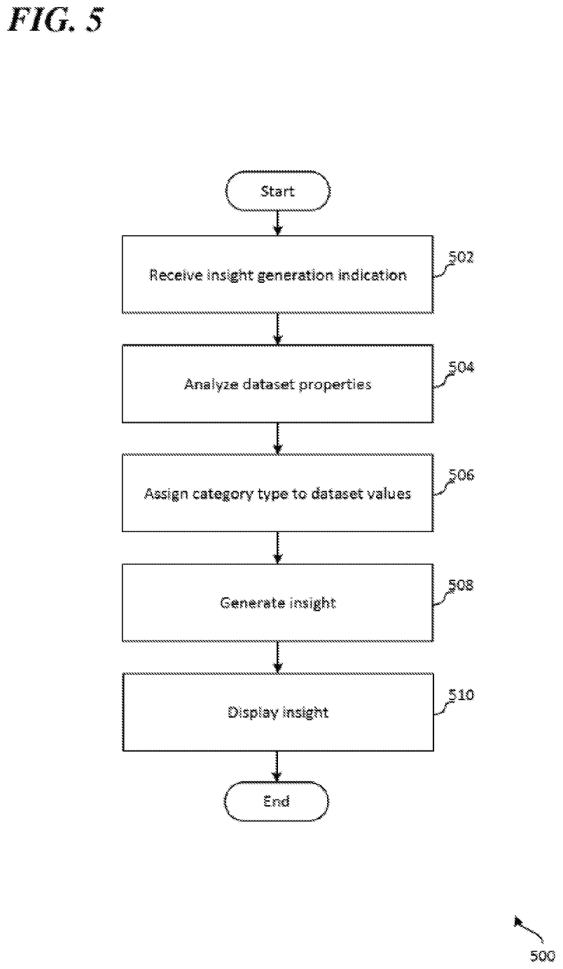

FIG. 5 is a second exemplary method 500 for providing dataset insights for a productivity application. The method 500 begins at a start operation and flow continues to operation 502 where an indication to generate an insight associated with a dataset is received. The indication may comprise a typed command, a verbal command, a command issued via a mouse click, a command issued by interacting with the dataset, a user interaction associated with a user interface element of a productivity application, and/or an automatic indication received based on automated analysis of one or more datasets associated with a productivity application (for example, an analysis of one or more datasets based on the datasets being created, the analysis of one or more datasets based on information associated with the one or more datasets being modified, or the like).

From operation 502, flow continues to operation 504 where one or more properties associated with the dataset are analyzed. The one or more properties may comprise values included in the dataset, values of one or more datasets related to the dataset, column headers associated with the dataset, column footers associated with the dataset, font properties of data in the dataset, relationships of data in the dataset to one or more other datasets, and metadata associated with the dataset. According to some examples, the analysis of the one or more properties may comprise identifying one or more patterns associated with a plurality of values in the dataset, identifying relationships of the dataset to one or more other datasets, and identifying past user interaction related to the dataset or one or more similar datasets.

From operation 504, flow continues to operation 506 where a category type is assigned to a plurality of values of the dataset based on the analysis of the one or more properties at operation 504. In some examples, the category type may comprise a value type, such as, for example, a text value type, a number value type, a symbol value type, a denomination value type, a date value type, a specific function value type, an address value type, a person name value type, and an object type value type (for example, company names, book names, social security numbers, performance ratings, sales figures, geographic locations, colors, shapes, category types).

From operation 506, flow continues to operation 508 wherein an insight associated with the dataset is generated by applying at least one function to a plurality of values of the dataset. In some examples, the at least one function may comprise one or more of a sort function, an averaging function, an add function, a subtract function, a multiply function, a divide function, a graph generation function, a chart generation function, a pattern identification function, a summarization function, and a projection function. In some examples, the at least one function may be applied based on past user history associated with the productivity application, a type of user query corresponding to the received indication to generate the insight, and the ability to apply the at least one function to value types included in the dataset.

From operation 508, flow continues to operation 510 where the generated insight is caused to be displayed in a user interface of the productivity application. In some examples, the displayed insight may comprise charts, tables, pivot tables, graphs, textual information, interactive visual application elements, selectable application elements for audibly communicating information associated with the dataset, and/or pictures. The displayed insight may provide visual and/or audible indications of information associated with the dataset, summaries of key takeaways associated with the dataset, comparisons of information from the dataset, summaries of key takeaways associated with the dataset, comparisons of information of information from the dataset with one or more other datasets related to the dataset, and projections for one or more values or categories associated with the dataset.

From operation 510, flow continues to an end operation, and the method 500 ends.

The systems, methods, and devices described herein provide technical advantages for interacting and viewing information associated with productivity applications. For example, users may be provided with dataset insights, which may be generated with a specific querying user taken into account that visually and/or audibly communicate key takeaways associated with a dataset, summaries of information included in a dataset, comparisons of data in a dataset, comparisons of data in a dataset with data from other related datasets, projections associated with a dataset, or a combination thereof.

As described herein, an insight service may process dataset insight queries in a single, portable, format via an insight API and provide one or more generated insights of one or more insight types, to a plurality of different application types (which may each support various different insight features) in a portable format. The ability of the insight service to uniformly analyze, process, and generate insights in a portable format reduces processing costs (CPU cycles) that would otherwise be required for multiple application-specific insight services or multiple application-specific insight service engines to perform the analysis, processing, and generation of insights specific to each application type from which insight queries may be received.

The ability to generate insights for datasets based on the analysis of user provided metadata for datasets, metadata associated with datasets based on dataset creation, and/or the association of metadata with datasets based on the analysis of dataset information via an insight service and the mechanisms described herein allows for the surfacing of summary and/or key information associated with datasets, which can be interacted with in various ways to quickly view the result of modifications to surfaced insights and/or dataset values. These enhanced features provide a better user experience, the ability to quickly and efficiently identify and view relevant information associated with large datasets that may not otherwise be readily identifiable due to the size of a dataset, and cost savings at least in the time required to identify relevant data in productivity applications and the processing costs required to identify relevant data in datasets and navigate large datasets comprised in productivity applications and/or datasets from which one or more values of a productivity application depend.

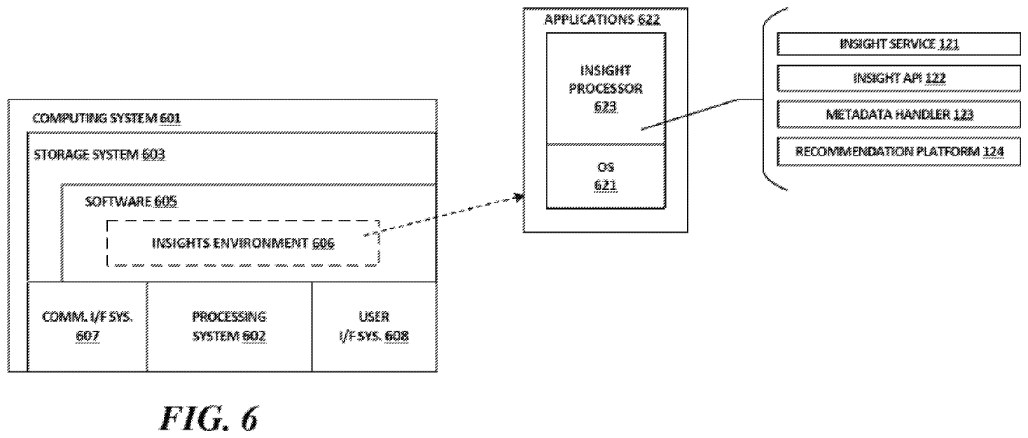

Turning now to FIG. 6, computing system 601 is presented. The computing system 601 is representative of any system or collection of systems in which the various operational architectures, scenarios, and processes disclosed herein may be implemented. For example, computing system 601 can be used to implement the user platform 110 or the insight platform 120 of FIG. 1. Examples of the computing system 601 include, but are not limited to, server computers, cloud computing systems, distributed computing systems, software-defined networking systems, computers, desktop computers, hybrid computers, rack servers, web servers, cloud computing platforms, and data center equipment, as well as any other type of physical or virtual server machine, and other computing systems and devices, as well as any variation or combination thereof. When portions of computing system 601 are implemented on user devices, example devices include smartphones, laptop computers, tablet computers, desktop computers, gaming systems, entertainment systems, and the like.

The computing system 601 may be implemented as a single apparatus, system, or device or may be implemented in a distributed manner as multiple apparatuses, systems, or devices. As illustrated in FIG. 6, in some embodiment, the computing system 601 includes, but is not limited to, a processing system 602, a storage system 603, software 605, a communication interface system 607, and a user interface system 608. The processing system 602 is operatively coupled with the storage system 603, the communication interface system 607, and the user interface system 608.

The processing system 602 loads and executes the software 605 from the storage system 603. The software 605 includes insights environment 606, which is representative of the processes discussed with respect to the preceding figures. When executed by the processing system 602 to enhance data insight generation and handling, the software 605 directs processing system 602 to operate as described herein for at least the various processes, operational scenarios, and environments discussed in the foregoing implementations. The computing system 601 may optionally include additional devices, features, or functionality not discussed for purposes of brevity.

Referring still to FIG. 6, the processing system 602 may comprise a microprocessor and processing circuitry that retrieves and executes the software 605 from the storage system 603. Processing system 602 may be implemented within a single processing device but may also be distributed across multiple processing devices or sub-systems that cooperate in executing program instructions. Examples of the processing system 602 include general purpose central processing units, application specific processors, and logic devices, as well as any other type of processing device, combinations, or variations thereof.

The storage system 603 may comprise any non-transitory computer readable storage media readable by the processing system 602 and capable of storing the software 605. The storage system 603 may include volatile and nonvolatile, removable and non-removable media implemented in any method or technology for storage of information, such as computer readable instructions, data structures, program modules, or other data. Examples of storage media include random access memory, read only memory, magnetic disks, resistive memory, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations, the storage system 603 may also include computer readable communication media over which at least some of the software 605 may be communicated internally or externally. The storage system 603 may be implemented as a single storage device but may also be implemented across multiple storage devices or sub-systems co-located or distributed relative to each other. The storage system 603 may comprise additional elements, such as a controller, capable of communicating with processing system 602 or possibly other systems.

The software 605 may be implemented in program instructions and among other functions may, when executed by the processing system 602, direct the processing system 602 to operate as described with respect to the various operational scenarios, sequences, and processes illustrated herein. For example, the software 605 may include program instructions for implementing the dataset processing environments and platforms discussed herein.

In particular, the program instructions may include various components or modules that cooperate or otherwise interact to carry out the various processes and operational scenarios described herein. The various components or modules may be embodied in compiled or interpreted instructions or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. The software 605 may include additional processes, programs, or components, such as operating system (OS) software or other application software in addition to processes, programs, or components included in an insights environment 606. The software 605 may also comprise firmware or some other form of machine-readable processing instructions executable by the processing system 602.

In general, the software 605 may, when loaded into the processing system 602 and executed, transform a suitable apparatus, system, or device (of which the computing system 601 is representative) overall from a general-purpose computing system into a special-purpose computing system customized to facilitate data insight generation and handling. Indeed, encoding the software 605 on the storage system 603 may transform the physical structure of the storage system 603. The specific transformation of the physical structure may depend on various factors in different implementations of this description. Examples of such factors may include, but are not limited to, the technology used to implement the storage media of the storage system 603 and whether the computer-storage media are characterized as primary or secondary storage, as well as other factors.

For example, when the computer readable storage media are implemented as semiconductor-based memory, the software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

The insights environment 606 includes one or more software elements, such as OS 621 and applications 622. These elements can describe various portions of the computing system 601 with which users, dataset sources, machine learning environments, or other elements, interact. For example, the OS 621 can provide a software platform on which the applications 622 are executed and allows for processing datasets for insights and visualizations among other functions. In one example, an insight processor 623 implements elements from the insight platform 120 of FIG. 1, such as elements 122-124.

The communication interface system 607 may include communication connections and devices that allow for communication with other computing systems (not shown) over communication networks (not shown). Examples of connections and devices that together allow for inter-system communication may include network interface cards, antennas, power amplifiers, radio frequency (RF) circuitry, transceivers, and other communication circuitry. The connections and devices may communicate over communication media to exchange communications with other computing systems or networks of systems, such as metal, glass, air, or any other suitable communication media. Physical or logical elements of the communication interface system 607 can receive datasets, transfer datasets, metadata, and control information between one or more distributed data storage elements, and interface with a user to receive data selections and provide insight results, among other features.

The user interface system 608 is optional and may include a keyboard, a mouse, a voice input device, a touch input device, or other device for receiving input from a user. Output devices such as a display, speakers, web interfaces, terminal interfaces, and other types of output devices may also be included in the user interface system 608. The user interface system 608 can provide output and receive input over a network interface, such as the communication interface system 607. In some examples, the user interface system 608 might packetize display or graphics data for remote display by a display system or a computing system coupled over one or more network interfaces. Physical or logical elements of the user interface system 608 can receive datasets or insight selection information from users or other operators and provide processed datasets, insight results, or other information to users or other operators. The user interface system 608 may also include associated user interface software executable by the processing system 602 in support of the various user input and output devices discussed above. Separately or in conjunction with each other and other hardware and software elements, the user interface software and user interface devices may support a graphical user interface, a natural user interface, or any other type of user interface.

Communication between the computing system 601 and other computing systems (not shown) may occur over a communication network or networks and in accordance with various communication protocols, combinations of protocols, or variations thereof. Examples of such protocols include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the hypertext transfer protocol (HTTP), Internet protocol (for example, IP, IPv4, IPv6, and the like), the transmission control protocol (TCP), and the user datagram protocol (UDP), as well as any other suitable communication protocol, variation, or combination thereof.

As noted above in the summary section, the language of a dataset created and edited by a user may vary. For example, one user may create a dataset in English and another user may create a dataset in French. Similarly, in some embodiments, a single dataset may include data in different languages. Although a system of language-specific modules (recommenders) as described above may be created to process datasets in each language, this configuration quickly becomes complex and wastes memory and computing resources. For example, each recommender may need to be replicated for each possible language and all of these recommenders would need to be saved (remotely or locally) for each user. Furthermore, during use of the systems and methods as described above, the proper modules would need to be loaded and initialized, which wastes computing resources (for example, memory availability and processor bandwidth) as well as network resources.

To solve these and other technical problems, some embodiments described herein provide a language agnostic system for providing insights as described above. By utilizing language agnostic systems and methods, insights, as described herein, can be optimally provided without requiring the development, storage, loading, initializing, and execution of multiple language modules (recommenders), which can provide for more efficient use of computing and communication resources as well as provide for quicker processing and presentation of insights to a user.

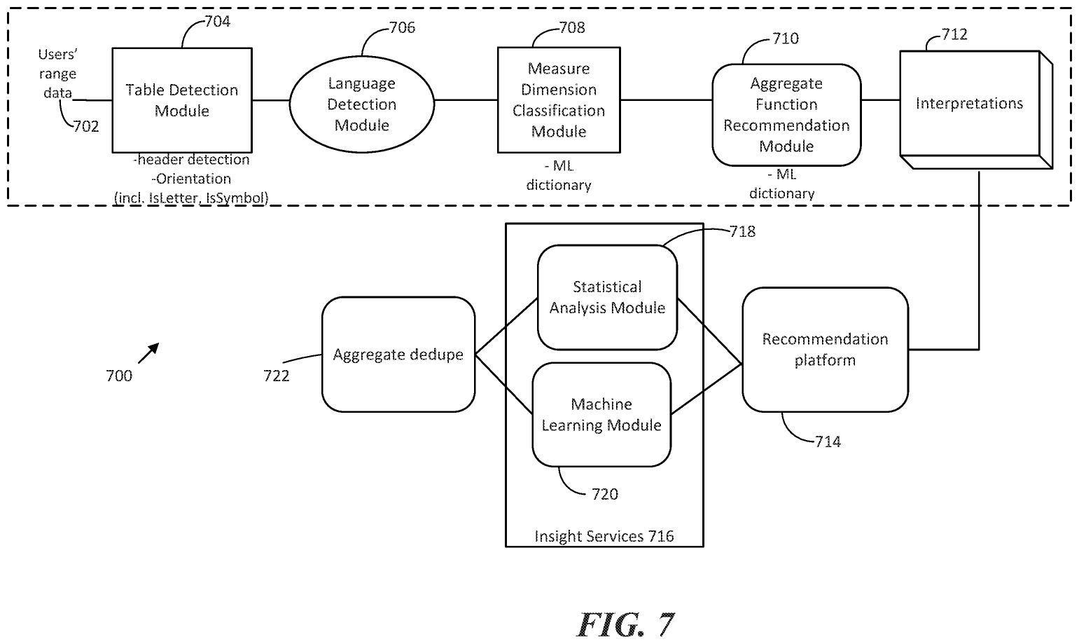

Turning now to FIG. 7, a data insight environment relating to an application 700 for generating dataset insights is shown. In some embodiments, the application 700 is executed using systems and environments described herein and may include a productivity application as described above. The application 700 may include or interact with a series of modules as shown in FIG. 7. In some examples, the application 700 is executed using a data visualization environment, such as data visualization environment 100, described above. Also, in some examples, the application 700 is executed using a computing system, such as computing system 601, also described above. In some examples, the modules shown in FIG. 7 may be substantially similar to modules described above, as will be noted in more detail below.

As illustrated in FIG. 7, one or more target datasets 702 are input to the application 700 representing user data as described above. In some embodiments, the user selects the target datasets 702 as described above, such as by selecting a range of data displayed within the application 700. The target datasets may include column headers, row headers, data values, metadata, etc. Additionally, the user may provide metadata for the target datasets 702, queries for the target datasets 702, or a combination thereof as also described above.

As illustrated in FIG. 7, a table detection module 704 processes the target datasets 702. The table detection module 704 may be configured to determine the structure of the provided datasets 702, as described above, such as with respect to the metadata handler 123 or the metadata manager 302. For example, the table detection module 704 may utilize one or more table detection services that detect data arranged into two-dimensional arrays, such as tables, as well as extract metadata that describes the data in the arrays (for example, table headers and data characteristics such as whether data is a symbol, a number, a text string, or the like). The table detection module 704 may be agnostic of the column orientation. For example, like the metadata manager 302, the table detection module 704 may be configured to detect a table orientation independent of metadata detection.

As shown in FIG. 7, the table detection module 704 is configured to communicate with a language detection module 706. The language detection module 706 is configured to apply one or more internal language services detect one or more languages of data included within the datasets 702. In some embodiments, the language detection module 706 processes one or more headers included in the dataset 702 (identified by the table detection module 706), data included in the dataset 702, or a combination thereof to extract language data. Alternatively or in addition to using internal services, in some embodiments, the language detection module 706 communicates with one or more external language services (for example, via an API) to determine a language of data included in the datasets 702. For example, the language detection module 706 may communicate with one or more external language determination programs (for example, web or server hosted programs), such as one or more external language determination programs provided by Microsoft's Bing Translator APIs. It should be understood, however, that other external language systems and programs are contemplated for performing language detection. In some examples, the external language determination programs analyze the dataset (optionally including the associated metadata) and provide language information to the language detection module 706. The language information may include information such as language type (for example, English or Italian), a desired translated language (for example, German to English), or the like.

Alternatively in addition to determining a language of the target datasets 702 using a language determination program (internal or external), the language detection module 706 may determine a language of the target datasets 702 based on language settings of the application 700 or a host computer or server executing or communicating with the application 700. In addition, in some embodiments, the language detection module 702 determines a language of the target datasets 702 based on user input designating a language of the datasets 702, such as user input provided via the application 700.

In some embodiments, the language detection module 706 is also configured to perform a word breaking function. The word breaking function breaks apart compound words or phrases, such as hyphenated words and may also pull apart phrases into individual words. The language detection module 706 may perform the word breaking function to aid language determination as the word breaking function may depend on the language of the target datasets 702. For example, in English, words are separated by white space. However, other non-English languages may combine multiple words into a single phrase with no spaces. In some embodiments, the results of the word breaking function may also be used as user data included in the datasets 702 or the associated metadata, which, as described above and below, is used to generate insights for the target datasets 702.

Based on the language determined by the language detection module 706, the table detection module 704 (or a separate module) may be configured to convert language-dependent data elements included in the datasets (for example, as parsed via the word breaking function) into a language-agnostic form, such as numerical data. For example, a date such as Jan. 1, 2018 may be converted to a numerical representation, such as the number “43101.” In some embodiments, the table detection module 704 is configured to perform language-specific parsing as well as apply calendar support for multiple calendar types (for example, Gregorian, Japanese, religious, and the like). As described above, this conversion allows insights to be generated for datasets in multiple different languages without the need for multiple language service packs or modules (recommenders) for individual languages. In some examples, in addition to or as an alternative to processing performed by the table detection module 704, the language detection module 706 may be configured to convert language-dependent data elements to language-agnostic data representations. For example, in some embodiments, the language detection module 706 may automatically interpret language-dependent data elements, regardless of language, as known objects (for example, dates) to allow for the conversion of these data elements to language-agnostic representations.

As illustrated in FIG. 7, the table detection module 704 outputs a table, including header information, to a measure dimension classification module 708. Similar to the measure v/s dimension classification component 308 described above, the measure dimension classification module 708 may be configured to assign a classification to each column and/or row in the table as containing either “dimension” data or “measure” data. The measure dimension classification module 708 may be configured to communicate with one or more machine learning (ML) dictionaries to determine whether the data associated with one or more rows or columns are measures (for example, data able to be mathematically manipulated) or dimensions (for example, categorical data).

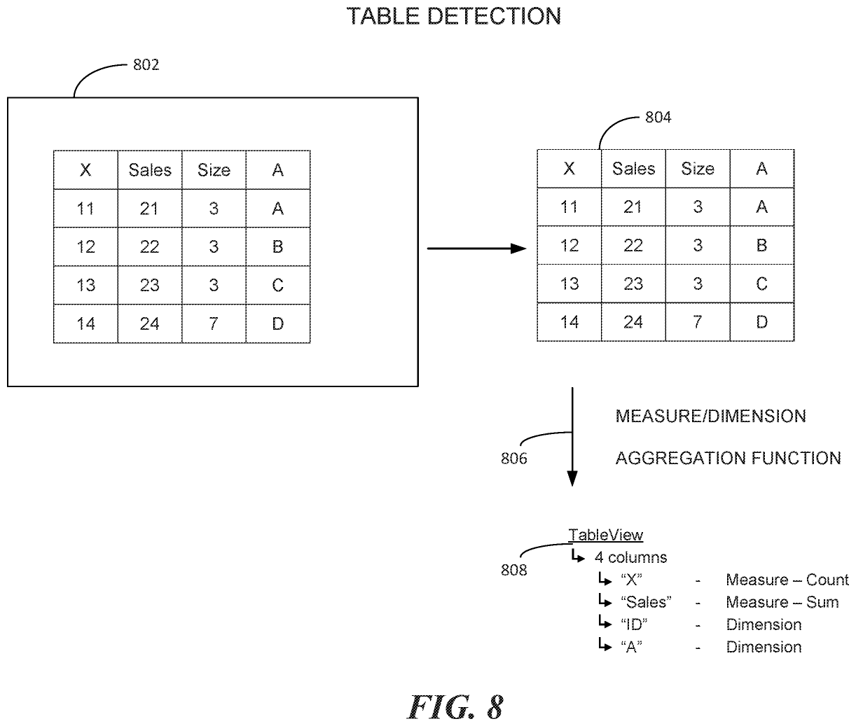

Turning briefly to FIG. 8, an example of this classification process is shown. As described above, a dataset 802 (the target datasets 702) is input to the table detection module 704, which extracts the headers and other table data. Words are extracted and a language used in the data is provided by the language detection module 706. Both the language data and the table data 804 are provided to the measure dimension classification module at 806. The measure dimension classification module 708 generates data associated with the table as shown at 808. The data output by the measure dimension classification module 708 can use both the table data provided by the table detection module 704 and the language data provided by the language detection module 706 to determine not only whether data in the dataset 802 is a measure or a dimension but also to categorize likely mathematical types of data. For example, as shown in 808 in FIG. 8, the “X” data is determined to be “measure” data and is further be determined to be a data type of “count,” and the “Sales” data may be determined to be “measure” data with a data type of “sum.” In some embodiments, the measure dimension classification module 708 evaluates not only the data within the “Sales” column to determine the data type but may also evaluate the term “sales” based on the language determined by the language detection module 706. Similarly, as shown in FIG. 8, in this example, the “ID” column is determined to be “dimension” (for example, based on the type of data and the header “ID”) and the “A” column is determined to be “dimension” data (for example, based on the data within the column, as well as the determined language of the data in both the column and the column header).

Returning now to FIG. 7, the measure dimension classification module 708 outputs the analyzed dataset to the aggregate function recommendation module 710. In some embodiments, the aggregate function recommendation module 710 suggests aggregation functions for each column, similar to the aggregation function detector component 310 described above. Accordingly, the aggregate function recommendation module 710 may be configured to generate a list of aggregation functions for measure data (as determined by the measure dimension classification module 708). The aggregate function recommendation module 710 may also be configured to generate modified sets of dimension data by applying one or more aggregation algorithms to the dataset output from the measure dimension classification module 708. The aggregate function recommendation module 710 may be configured to communicate with one or more ML dictionaries to make these suggestions and modifications.

The recommended aggregation functions are provided to the interpretations module 712. The interpretations module 712 evaluates the aggregation functions generated by the aggregate function recommendation module 710 and outputs likely aggregation functions based on the data provided by the aggregate function recommendation module 710. In some embodiments, the interpretations module 712 outputs multiple recommendations, and the recommendations may include multiple different types of data aggregations, such as row-based aggregations and column-based aggregations.

The recommendations output by the interpretations module 712 may be processed in a manner similar to those described above. For example, a recommendation platform 714, which includes one or more recommendation modules, such as the recommendation modules 130 described above, performs insight analysis as described above. As discussed herein, this analysis can include analysis processes derived by processing the user data, metadata, and query structure and content, along with other data, such as past usage activities, activity signals, usage modalities that are found in the data, or combinations thereof. In particular, the target datasets 702 can be processed according to various formulae, equations, functions, and the like to determine patterns, outliers, majorities, minorities, segmentations, other properties of the target dataset, or combinations thereof that can be used to visualize the data, present conclusions related to the target dataset, or both. In some embodiments, many different analysis processes can be performed in parallel.

As illustrated via the dashed box illustrated in FIG. 7 representing language-dependent aspects of the environment (components outside of the dashed box are language-agnostic), the recommendation platform 714 may be language agnostic. However, in other embodiments, the recommendation platform 714 may also be configured to strip away language aspects of the data, analyze the metadata of the data structures, and provide recommended outputs to one or more insight services 716. For example, the recommendation platform 714 may be configured to strip out currency identifiers, and a recommender could query for a given data value IsCurrency and the platform 714 guarantees that this check was performed in a language agnostic form.

Insight results are determined by the recommendation platform 714 (via one or more language-agnostic recommenders) and are provided to one or more language-agnostic insight services 716 for various formatting and standardization of the data. Insight services 716 may be similar to the insight service 121 described above. Insight services 716 interpret the insight results in the portable format to customize, render, or otherwise present the insight results to a user within the application 700. For example, when the insight results procedurally describe charts, graphs, or other graphical representations of insight results, the application 700 can present these graphical representations. In one example, the insight results are displayed to the user in the language detected by the language detection module 706. For example, where the dataset 702 is determined to be in a different language than the language associated with the user device, the insight results may be displayed in the user device language.

In some embodiments, the insight services 716 also include a statistical analysis module 718. The statistical analysis module 718 may be configured to analyze the datasets and recommendations output by the recommendation platform 714 to perform more granular analysis on the datasets and recommendations to provide a more detailed recommendation to a user.

The insight service 716 may further include a machine learning module 720. The machine learning module 720 may use machine learning techniques to further generate insights to be presented to the user. This design advantageously supports the ability for machine learning techniques to be trained. Accordingly, as updates are made to the supported recommendation module feature set and associated generation logic, each recommendation module can train a new model that can be used to match the new version, and the production service can ensure that the hosted models are synchronized with their feature set version. To ensure that the machine learning and training models are working as expected, the same logic may be used to generate the features that are used to train the models as well as validate and run them.

The insight services 716 output data to the aggregate dedupe module 722. The aggregate dedupe module 722 is configured to the generated results from the insight services 716 and compile the results into a single list, which can be used to generate one or more views or insight results. In some embodiments, the insights results provided to a user are presented in a language native to the user, the detected language of the target datasets 702, or in both or multiple languages.

By determining the language used in the target datasets 702, the application 700 can both output data (insights) in the determined language, and analyze the data agnostically by disregarding language within the data, as described above. In some examples, this language independence can allow a user to operate a system in one language while the datasets 702 are in a different language, all without requiring the user to translate or otherwise modify the datasets. As noted above, by using a language agnostic model, recommendations can be delivered to the user quicker, as the application 700 does not need to load multiple modules (recommenders) for each different language that is detected. The language agnostic model further reduces memory storage requirements due to the elimination of a need for multiple modules. Finally, development of additional data analysis modules and module training (such as the machine learning module) can be done more efficiently, as they can be trained and developed in a single language.

It should be understood from the above description, that the language detection module 706 and associated language evaluation functions may be used interchangeably with any of the processes, systems, environments and/or applications described herein. Also, the functionality described above with respect to any of the modules may be distributed, combined, and sequenced in various configurations. For example, in some embodiments, the table detection module 704 is configured to detect symbols or letters in a “global” way that is not language-specific. Therefore, in some embodiments, the table detection module 704 may initially process data to detect symbols or letters and pass the processed data set to the language detection module 706. In other embodiments, flow may pass between the table detection module 704 and the language detection module 706 one or more times to complete processing of the dataset as described above with respect to these modules.

The functional block diagrams, operational scenarios and sequences, and flow diagrams provided in the figures are representative of exemplary systems, environments, and methodologies for performing novel aspects of the disclosure. While, for purposes of simplicity of explanation, methods included herein may be in the form of a functional diagram, operational scenario or sequence, or flow diagram and may be described as a series of acts, it is to be understood and appreciated that the methods are not limited by the order of acts, as some acts may, in accordance therewith, occur in a different order or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the disclosure. Those skilled in the art will also appreciate that the features described above can be combined in various ways to form multiple implementations. As a result, the invention is not limited to the specific implementations described above.

1. An electronic processor implemented method of providing insight results for a dataset, the method comprising:
receiving the dataset and a user query relating to the dataset;
determining a language associated with a language-dependent data element in the dataset;
converting based on the language, the language-dependent data element into a numerical representation of the language-dependent data element and assigning a classification to the numerical representation of the language-dependent data element;
generating an insight result based on the user query and the dataset including the numerical representation of the language-dependent data element and the assigned classification, wherein the insight result comprises at least one result from a data analysis of the dataset based on the user query; and
outputting the insight result to a user interface.

2. The method of claim 1, wherein the language-dependent data element is selected from a group consisting of a column header of data included in the dataset, a row header of data included in the dataset, and a data value included in the dataset.

3. The method of claim 1, wherein determining the language associated with the language-dependent data element includes transmitting at least a portion of the dataset to a language determination program via an application programming interface.

4. The method of claim 3, wherein the language determination program provides a language type and a desired translation language.

5. The method of claim 1, further comprising determining metadata describing a property of the dataset wherein the property comprises at least one selected from a group consisting of a column header associated with the dataset, a column footer associated with the dataset, and metadata associated with the dataset describing a value property types associated with a data value in the dataset and wherein generating the insight result includes generating the insight result based on the metadata, the user query, and the dataset including the numerical representation and the assigned classification.

6. The method of claim 1, further comprising:
receiving an indication to provide information associated with a criteria utilized in generating the insight result; and
in response to receiving the indication, outputting a description of the criteria to the user interface.

7. A system for providing dataset insights for a dataset, the system comprising:
a memory for storing executable program code; and
one or more electronic processors, functionally coupled to the memory, the one or more electronic processors configured to:
receive the dataset and a user query relating to the dataset;
determine a language associated with a language-dependent data element in the dataset;
convert, based on the language, the language-dependent data element into a numerical representation of the language-dependent data element;
assign a classification to the numerical representation of the language-dependent data element;
provide the user query, the dataset including the numerical representation of the language-dependent data element and the assigned classification to a recommendation element for generating an insight result for the dataset, wherein the insight result comprises at least one result from a data analysis of the dataset based on the query; and
output the insight result to a user interface.

8. The system of claim 7, wherein the language-dependent data element is selected from a group consisting of a column header of data included in the dataset, a row header of data included in the dataset, and data included in the dataset.

9. The system of claim 7, wherein the one or more electronic processors are configured to determine the language associated with the language-dependent data element by transmitting the at least a portion of the dataset to a language determination program via an application programming interface.

10. The system of claim 9, wherein the language determination program provides at least one of a language type and a desired translation language.

11. The system of claim 7, wherein the one or more electronic processors are further configured to:
process the data to determine metadata describing a property of the dataset, the property comprising at least one selected from a group consisting of a column header associated with the dataset, a column footer associated with the dataset, and metadata associated with the dataset comprising a description of a value property type associated with a data value in the dataset, and
wherein the one or more electronic processors are configured to generate the insight result by generating the insight result based on the metadata, the user query, and the dataset including the numerical representation and the assigned classification.

12. The system of claim 7, wherein the one or more electronic processors are further configured to:
receive an indication to provide information associated with one or more criteria utilized in generating the insight result; and
in response to receiving the indication, outputting a description of the criteria to the user interface.

13. The system of claim 7 wherein the insight result, as displayed within the user interface, includes at least one selected from a group consisting of a graph associated with a plurality of data values of the dataset; a chart associated with a plurality of data values of the dataset; and a pivot table associated with a plurality of data values of the dataset.

14. A non-transitory computer-readable storage device comprising instructions that, when executed by one or more electronic processors, perform a set of functions to provide dataset insights for a dataset, the set of functions comprising:
receiving a user query to generate an insight associated with the dataset;
determining a language associated with a language-dependent data element in the dataset;
converting, based on the data, the language-dependent data element into a numerical representation of the language-dependent data element and assigning a classification to the numerical representation of the language-dependent data element;
generating an insight result for the dataset by providing the user query and the dataset including the numerical representation of the language-dependent data element and the assigned classification to a recommendation element configured to perform a data analysis of the data based on the user query; and
outputting the insight result to a user interface.

15. The computer-readable storage device of claim 14, wherein the language-dependent data element is selected from a group consisting of a column header of data included in the dataset, a row header of data included in the dataset, and a data value included in the dataset.

16. The computer-readable storage device of claim 14, wherein determining the language associated with the language-dependent data element includes transmitting at least a portion of the dataset to a language determination program via an application programming interface.

17. The computer-readable storage device of claim 16, wherein the language determination program provides at least one of a language type and a desired translation language.

18. The computer-readable storage device of claim 14, wherein the set of functions further comprising:
processing the dataset to determine metadata describing a property of the dataset, the property selected from a group consisting of a column header associated with the dataset, a column footer associated with the dataset, and metadata associated with the dataset comprising a description of a value property type associated with a data value in the dataset,
wherein generating the insight result includes generating the insight result based on the metadata, the user query, and the dataset including the numerical representation and the assigned classification.

19. The computer-readable storage device of claim 14, further comprising:
receiving an indication to provide information associated with a criteria utilized in generating the insight result; and
in response to receiving the indication, outputting to the user interface a description of the criteria.

20. The computer-readable storage device of claim 14, wherein the insight result as displayed in the user interface is selected from one of: a graph associated with a plurality of values of the dataset, a chart associated with a plurality of values of the dataset, and a pivot table associated with a plurality of values of the dataset.
